(19) United States
(12) Patent Application Publication
(10) Pub. No.: US 2007/0275711 A1
(43) Pub. Date: Nov. 29, 2007

(54) Automatic credit and reconnect of dropped calls

(76) Inventors: Ajay K. Buti, Naperville, IL (US); Sanjeev Mahajan, Naperville, IL (US)

Correspondence Address: PATTI , HEWITT & AREZINA LLC, ONE NORTH LASALLE STREET, 44TH FLOOR, CHICAGO, IL, 60602, US

(21) Appl. No.: 11/439,775

(22) Filed: May 24, 2006

(51) Int. Cl. H04Q 7/20

(52) U.S. Cl. 455/423

(57) ABSTRACT

An apparatus and method are provided for receiving a message that a mobile communications device has experienced a dropped call, and updating an account of a user of the mobile communications device to provide a credit for the dropped call upon receipt of the message. The message is received without involvement from the user of the mobile communications device. Optionally, the mobile communications device may be reconnected to a last call number when a signal becomes available.

### TECHNICAL FIELD

This invention relates to the art of mobile phones, and more particularly to automatically updating accounts of mobile phone users to provide credits for dropped calls, and reconnecting mobile phones to a last call number.

### BACKGROUND

Mobile phone calls that terminate unexpectedly are referred to as dropped calls. A dropped call may occur because of radio frequency (RF) signal conditions such as a) when the RF signal is interrupted by an obstruction, such as a building or a tunnel, b) when the RF signal is transferred from one transmission tower to another, c) when a mobile caller tries to make a call during a high usage time, and d) when a mobile caller moves outside of a wireless service provider's coverage area. Also, a dropped call may occur because of other conditions, such as when a mobile phone, or other wireless communications device, at the other end of a call loses battery power and stops transmitting abruptly. Improving network quality is a big financial incentive for wireless service providers, as customers experiencing call quality problems are more likely to switch service providers in the future.

Wireless service providers have attempted to address the problem of dropped calls due to radio frequency signal conditions by expanding their network coverage and increasing network capacity. Also, wireless service providers offer credits for individual dropped calls. Disadvantageously, there are still many areas, e.g., rural areas, which do not have good coverage because the cost of erecting a transmission tower is too high for only a few customers. Also disadvantageously, subscribers who have experienced a dropped call must initiate a call to their service provider and navigate a menu-driven response system to receive a credit for the dropped call.

One prior art telephone feature, i.e., redial, allows a call originator to redial the telephone number of the last called party by pressing a redial button on a telephone handset. Disadvantageously, dropped call network conditions, e.g., no RF signal because the caller is outside of a service provider's coverage area, may exist which may prevent the reconnection of the call. Also disadvantageously, activating the redial feature on a mobile phone handset may be inconvenient if the call originator is a) driving, diverting the attention of the call originator away from the road, or b) otherwise preoccupied.

Another prior art telephone service, *69, allows a called party to call back the telephone number of the last call received. Disadvantageously, the called party is required to initiate this feature, and there is no guarantee that a connection to the call originator will be made at the time of the call back. Also disadvantageously, the *69 service works only if the last call received was from a call originator within a given proximity to the called party and if the telephone number of the last call received has not been blocked.

### SUMMARY

It has been recognized, in accordance with the principles of the invention, that the problems of the prior art can be overcome by a network-based automatic credit and reconnect of dropped calls system. More specifically, the automatic credit and reconnect of dropped calls system assists in crediting a mobile communications device user for dropped calls and reconnecting the mobile communications device to a last call number by a) receiving a message that a mobile communications device has experienced a dropped call and b) updating, upon receipt of the message, an account of a user of the mobile communications device to provide a credit for the dropped call, c) wherein the message is received without involvement from the user of the mobile communications device. Optionally, the mobile communications device may be reconnected to the last call number.

### DESCRIPTION OF THE DRAWINGS

FIG. 1 shows a network view of an illustrative embodiment of the present invention of an automatic credit and reconnect of dropped calls system; and

FIG. 2 shows an illustrative flow chart for a method of operating the automatic credit and reconnect of dropped calls system.

### DETAILED DESCRIPTION

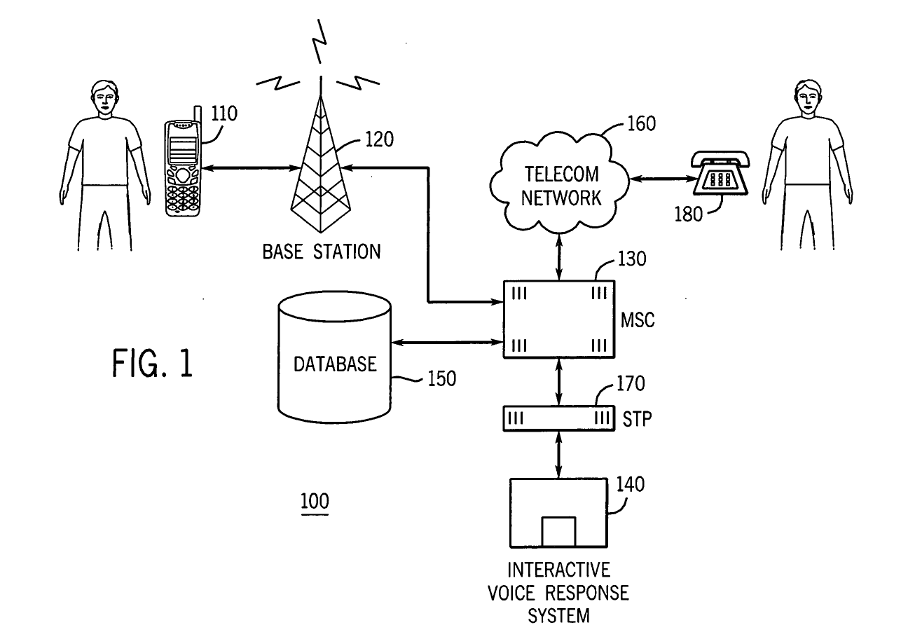

FIG. 1 is a diagram illustrating an automatic credit and reconnect of dropped calls system arranged in accordance with the principles of the invention. As shown in FIG. 1, the automatic credit and reconnect of dropped calls system 100 includes mobile device 110, base station 120, mobile switching center (MSC) 130, interactive voice response server 140, data base (DB) 150, telecom network 160, and signal transfer point (STP) 170. Also, called party 180 is shown.

Mobile device 110 is a mobile communications device capable of wirelessly connecting to a communications network, e.g., telecom network 160, via a telephone switching network having wireless technologies that may include one or more mobile base stations, e.g., base station 120, connected to one or more mobile switches, e.g., mobile switching center (MSC) 130, allowing the user of mobile device 110 to communicate with a called party, e.g., called party 180. Mobile device 110 is capable of sending and receiving voice calls, email, SMS, microbrowser messages or text messaging, etc. Mobile device 110 may use an air interface standard such as Code Division Multiple Access (CDMA), Time Division Multiple Access (TDMA), Universal Mobile Telecommunications System (UMTS), Global System for Mobile Communications (GSM), etc., not shown, or any other standard or protocol which supports voice calls, email, SMS, microbrowser messages or text messaging.

In one embodiment of the invention, mobile device 110 may be a small, light-weight portable mobile telephone, e.g., pocket telephone. In another embodiment of the invention, mobile device 110 may be a mobile telephone installed in an engine-driven vehicle and supplied with current from the vehicle electrical system. In an alternative embodiment of the invention, mobile device 110 may be a personal digital assistance (PDA) device, a notebook computer, a two-way pager or other suitable wireless communications devices.

Base station 120 is a radio transmitter/receiver that maintains communications with mobile phones, e.g., mobile device 110, within a given range, e.g., a cell site. Base station 120 connects calls from mobile device 110 to a mobile switching center, e.g., MSC 130, which may connect the calls to the public switched telephone network (PSTN). Base station 120 may be capable of distinguishing between a) calls terminated by call originators and called parties and b) calls dropped due to loss of a radio frequency (RF) signal. Illustratively, mobile device 110 may transmit a packet of digitized voice to base station 120 at a fixed interval, e.g., 20 milliseconds for CDMA. If base station 120 does not receive packets from mobile device 110 in a multiple of the fixed interval, then base station 120 assumes that mobile device 110 is unreachable due to a dropped call. Base station 120 may transmit a message to MSC 130 when the dropped call has occurred informing MSC 130 that the dropped call occurred for mobile device 110. Base station 120 may identify mobile device 110 by its mobile station identity (MSID). Base station 120, in one embodiment, comprises one or more of a Flexent® CDMA 450 MHz Modular Base Station (Lucent Technologies).

MSC 130 is a telecommunications switch capable of switching calls between a plurality of endpoints via a wireless network connected to a public switched telephone network (PSTN), e.g., telecom network 160. MSC 130 has a call control component, not shown, that monitors all mobile phone calls within its serving area, tracks the location of all mobile phone-equipped vehicles traveling within its service area, arranges handoffs between switches, keeps track of billing information, etc.

MSC 130 may maintain a billing record for a mobile phone, e.g., mobile device 110, located in the serving area of MSC 130 that places a call. Illustratively, the billing record may comprise one or more automatic message accounting (AMA) billing records. MSC 130 may update an AMA billing record upon an occurrence of a billable event associated with the mobile phone.

When base station 120 determines that a call from mobile device 110 has been dropped due to loss of the RF signal, base station 120 transmits a message to MSC 130 identifying mobile device 110 as having experienced the dropped call. The call control of MSC 130 may determine that the call has been dropped based on a lack of packet transmission between base station 120 and mobile device 110. Upon receipt of the message from base station 120, MSC 130 may update the account of the user of mobile device 110 to provide a credit for the dropped call. In one embodiment of the invention, MSC 130 may update an AMA billing record to credit the account of the user of mobile device 110 for a predetermined number of minutes, e.g., 1 minute, for the dropped call. In another embodiment of the invention, MSC 130 may transmit a message directly to a billing system, not shown, to credit the account of the user of mobile device 110 for a predetermined number of minutes, e.g., 1 minute, for the dropped call.

A predetermined interval, e.g., 4 seconds, after the dropped call, the call control of MSC 130 may determine whether a RF signal is available for mobile device 110 by obtaining the telephone number of the user of mobile device 110 from memory, not shown, and generating a call to mobile device 110. The predetermined interval delay is necessary because mobile device 110 may still be in an area of poor coverage immediately after the dropped call. MSC 130 may attempt to contact mobile device 110 for a predetermined interval or a predetermined number of times before a retry timer, not shown, expires. When the RF signal is available, MSC 130 may inform the user of mobile device 110, via interactive voice response server 140, that a) the account of the user of mobile device 110 has been credited for a predetermined number of minutes for the dropped call and b) the call may be re-established, if desired. If the user of mobile device 110 desires to continue the prior call, then MSC 130 acts upon the response in real-time to a) obtain the telephone number of a last call number, e.g., called party 180, from memory, b) generate a call to the last call number, and c) connect the calls to re-establish the prior call. The last call number may be a telephone number of a called party or a call originator. If the user of mobile device 110 does not desire to continue the prior call, then MSC 130 terminates the connection to mobile device 110.

MSC 130 is connected to interactive voice response server 140, database 150 and a billing system, not shown. MSC 130, in one embodiment, comprises one or more of a 5ESS® 2000—Switch Mobile Switching Center (MSC) (Lucent Technologies).

STP 170 is a packet switch that routes signaling messages on a signaling system 7 (SS7) network. STP 170 may be used to route signaling messages between MSC 130 and interactive voice response server 140.

Interactive voice response server 140 provides interactive voice messages and announcements to mobile phone users, e.g., the user of mobile device 110, after MSC 130 has contacted the mobile phone users to attempt to reconnect a last call number after a dropped call. Upon being connected to a mobile phone after the dropped call, interactive voice response server 140 may inform the mobile phone user via an automated voice announcement that the account of the mobile phone user has been credited for the dropped call. Also, interactive voice response server 140 may ask the mobile phone user, via a human sounding automated voice, one or more questions to which the mobile phone user may respond to determine whether to attempt to reconnect the call. Illustratively, interactive voice response server 140 may inquire, a) “Do you want to reconnect to the last call number now?” or b) “Would you like to reconnect to the last call number at a later time?”.

After making the inquiry, interactive voice response server 140 may wait for the response. The response to these questions may be answered by either a voice response or by pressing keys on the mobile phone handset. In one embodiment of the invention, interactive voice response server 140 may use voice recognition to determine when the mobile phone user has completed the voice response. In another embodiment of the invention, interactive voice response server 140 may have a menu-driven program which recognizes dual tone multi-frequency (DTMF) responses made by pressing the keys on the mobile phone handset, e.g., “Press 1 if you want to reconnect to the last call number.”.

After interactive voice response server 140 collects the responses, MSC 130 will either re-establish the prior call or terminate the connection based on the desires of the mobile phone user. Optionally, interactive voice response server 140 may forward the mobile phone user's responses to a storage device, e.g., data base 150. Interactive voice response server 140 is connected to MSC 130. Interactive voice response server 140, in one embodiment, comprises one or more of an Enhanced Media Resource Server (eMRS) (Lucent Technologies).

Data base 150 stores and manages subscriber records, e.g., telephone numbers, addresses, telephone features subscribed to, etc. Data base 150 may store the responses of the mobile phone user, e.g., the user of mobile device 110, which were collected by interactive voice response server 140. The subscriber records used to populate data base 150 may be supplied by a home location register (HLR), a visiting location register (VLR), or other sources. Data base 150 may be stored local to MSC 130, or remote therefrom. Data base 150 is connected to MSC 130.

Those of ordinary skill in the art will readily be able to select MSCs, base stations, STPs, data bases and interactive voice response servers appropriate for use in any particular implementation of the automatic credit and reconnect of dropped calls system.

Advantageously, a credit may be provided automatically to a mobile phone user when a dropped call occurs without involvement, e.g., initiating calls to a service provider, from the mobile phone user. Also advantageously, the mobile phone user may be automatically reconnected to the last call number when the RF signal becomes available. Further advantageously, the last call number may be a telephone number of a called party or a call originator.

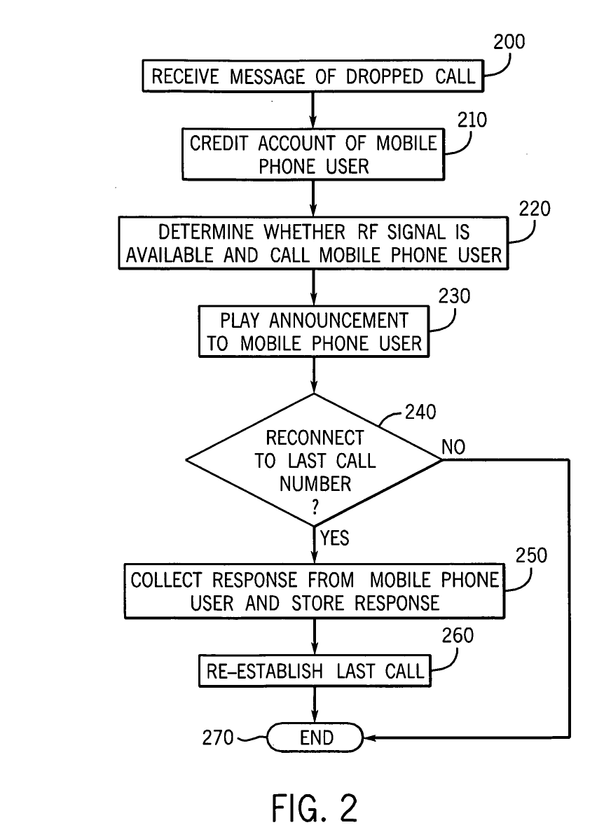

FIG. 2 shows a flow chart of the operation of the automatic credit and reconnect of dropped calls system in accordance with the principles of the present invention. The process is entered in step 200 when MSC 130 (FIG. 1) receives a message from base station 120 that mobile device 110 has experienced a dropped call due to loss of the RF signal.

In step 210 (FIG. 2), MSC 130 (FIG. 1) updates an AMA billing record to credit the account of the user of mobile device 110 for a predetermined number of minutes for the dropped call. Alternatively, MSC 130 may transmit a message to a billing system to credit the account of the user of mobile device 110 for a predetermined number of minutes for the dropped call.

In step 220 (FIG. 2), MSC 130 (FIG. 1) determines whether a RF signal is available for mobile device 110 by attempting to contact mobile device 110 a predetermined interval after the dropped call. When the RF signal is available, MSC 130 generates a call to mobile device 110.

In step 230 (FIG. 2), MSC 130 (FIG. 1) signals interactive voice response server 140 via STP 170 to play an announcement to mobile device 110 that the account of the user of mobile device 110 has been credited for the dropped call.

In step 240 (FIG. 2), it is necessary to determine whether to reconnect mobile device 110 (FIG. 1) to the last call number. MSC 130 signals interactive voice response server 140 via STP 170 to play automated voice inquiries to mobile device 110. Interactive voice response server 140 may wait to detect a response. The user of mobile device 110 may respond via voice responses or by pressing the keys on the handset of mobile device 110.

If the test result in conditional branch point 240 (FIG. 2) is NO, indicating that the user of mobile device 110 (FIG. 1) does not want to re-establish the last call, then control is passed to step 270 (FIG. 2). If the test result in step 240 is YES, indicating that the user of mobile device 110 (FIG. 1) does want to re-establish the last call, then control is passed to step 250.

In step 250 (FIG. 2), interactive voice response server 140 (FIG. 1) collects the responses to the automated voice inquiries from the user of mobile device 110. Optionally, interactive voice response server 140 may forward the responses from the user of mobile device 110 to data base 150.

In step 260 (FIG. 2), MSC 130 (FIG. 1) generates a call to the last call number, and connects mobile device 110 to the last call number to re-establish the prior call.

The process is exited in step 270.

Wireless service providers may view a network-based capability of automatically reconnecting subscribers to a last call that had been dropped as a new revenue generating opportunity. Illustratively, in one embodiment of the invention, the automatic reconnect feature may be offered on a monthly subscription basis. Referring to FIG. 1, after crediting an account of the user of mobile device 110 for the dropped call, MSC 130 may query data base 150 to determine whether the user of mobile device 110 has subscribed to an automatic reconnect feature prior to attempting to reconnect mobile device 110 to the last call number, e.g., called party 180. If the user of mobile device 110 has subscribed to such a feature, then MSC 130 may generate a call to mobile device 110. Upon connection to mobile device 110, MSC 130 may signal interactive voice response server 140 to a) announce that the account of the user of mobile device 110 has been credited for a predetermined number of minutes for the dropped call and b) inquire whether to reconnect mobile device 110 to the last call number. If the response to the inquiry is affirmative, then MSC 130 may attempt to reconnect mobile device 110 to the last call number. If the response to the inquiry is negative, then no attempt will be made to reconnect mobile device 110 to the last call number and MSC 130 will terminate the connection. If the user of mobile device 110 has not subscribed to such a feature, then MSC 130 may generate a call to mobile device 110. Upon connection to mobile device 110, MSC 130 may signal interactive voice response server 140 to announce that the account of the user of mobile device 110 has been credited for a predetermined number of minutes for the dropped call, but no attempt will be made to reconnect mobile device 110 to the last call number.

Illustratively, in another embodiment of the invention, the automatic reconnect feature may be offered at a fee per use. Referring to FIG. 1, in this embodiment, after crediting an account of the user of mobile device 110 for the dropped call, MSC 130 may generate a call to mobile device 110. Upon connection to mobile device 110, MSC 130 may signal interactive voice response server 140 to a) announce that the account of the user of mobile device 110 has been credited for a predetermined number of minutes for the dropped call and b) inquire to the user of mobile device 110, “Would you like to reconnect to the last call number for a fee of 10 cents?”. If the response to the inquiry is affirmative, then MSC 130 may attempt to reconnect mobile device 110 to the last call number, e.g., called party 180. If the response to the inquiry is negative, then no attempt will be made to reconnect mobile device 110 to the last call number and MSC 130 will terminate the connection.

Illustratively, in yet another embodiment of the invention, the automatic reconnect feature may be offered as a free feature. Referring to FIG. 1, in this embodiment, after crediting an account of the user of mobile device 110 for the dropped call, MSC 130 may generate a call to mobile device 110. Upon connection to mobile device 110, MSC 130 may signal interactive voice response server 140 to a) announce that the account of the user of mobile device 110 has been credited for a predetermined number of minutes for the dropped call and b) announce that the prior call will be re-established automatically. Then MSC 130 automatically reconnects mobile device 110 to the last call number, e.g., called party 180.

The foregoing merely illustrates the embodiments of the invention. It will thus be appreciated that those skilled in the art will be able to devise various arrangements, which, although not explicitly described or shown herein, embody the principles of the invention, and are included within its spirit and scope.

What is claimed:

1. A method, comprising the steps of:
receiving a message that a mobile communications device has experienced a dropped call; and
updating, upon receipt of the message, an account of a user of the mobile communications device to provide a credit for the dropped call;
wherein the message is received without involvement from the user of the mobile communications device.

2. The method of claim 1 further comprising the step of determining whether to reconnect the mobile communications device to a last call number.

3. The method of claim 2 wherein the determining whether to reconnect step further comprises the steps of:
generating, after a predetermined interval, a first call to the mobile communications device;
transmitting a first signal to announce, via an automated voice message, that the account of the user of the mobile communications device has been credited for the dropped call;
transmitting a second signal to determine, via an automated voice inquiry, whether to reconnect the mobile communications device to the last call number; and
collecting at least one response to the automated voice inquiry from the user of the mobile communications device.

4. The method of claim 3 wherein the user of the mobile communications device responds to the automated voice inquiry via a technique selected from the group consisting of a) a voice response and b) pressing keys on a mobile communications device handset.

5. The method of claim 4 further comprising the step of transmitting at least one signal to store the response from the user of the mobile communications device.

6. The method of claim 3 further comprising the step of re-establishing a call to the last call number when the user of the mobile communications device requests the reconnect.

7. The method of claim 6 wherein the step of re-establishing the call to the last call number further comprises the steps of:
generating a second call to the last call number; and
connecting the first call to the second call.

8. The method of claim 1 wherein the mobile communications device is selected from the group consisting of a) a mobile phone, b) a personal digital assistance (PDA) device, c) a notebook computer, and d) a two-way pager.

9. The method of claim 1 wherein the step of updating, upon receipt of the message, the account of the user of the mobile communications device to provide the credit for the dropped call is selected from the group consisting of a) updating an automatic message accounting (AMA) billing record to credit the account of the user of the mobile communications device for the dropped call and b) transmitting a messaging to a billing system to credit the account of the user of the mobile communications device for the dropped call.

10. The method of claim 1 wherein the credit is a function of a predetermined number of minutes.

11. The method of claim 3 wherein the predetermined interval is at least 4 seconds.

12. An apparatus, comprising:
means for receiving a message that a mobile communications device has experienced a dropped call; and
means for updating, upon receipt of the message, an account of a user of the mobile communications device to provide a credit for the dropped call;
wherein the means for receiving excludes involvement from the user of the mobile communications device.

13. The apparatus of claim 12 further comprising means for determining whether to reconnect the mobile communications device to a last call number.

14. The apparatus of claim 13 wherein the means for determining further comprises:
means for generating, after a predetermined interval, a first call to the mobile communications device;
means for transmitting a first signal to announce, via an automated voice message, that the account of the user of the mobile communications device has been credited for the dropped call;
means for transmitting a second signal to determine, via an automated voice inquiry, whether to reconnect the mobile communications device to the last call number; and
means for collecting at least one response to the automated voice inquiry from the user of the mobile communications device.

15. The apparatus of claim 14 wherein the user of the mobile communications device responds to the automated voice inquiry via a technique selected from the group consisting of a) a voice response and b) pressing keys on a mobile communications device handset.

16. The apparatus of claim 14 further comprising means for transmitting at least one signal to store the response from the user of the mobile communications device.

17. The apparatus of claim 14 further comprising means for re-establishing a call to the last call number when the user of the mobile communications device requests the reconnect.

18. The apparatus of claim 17 wherein the means for re-establishing the call to the last call number further comprises the steps of:
means for generating a second call to the last call number; and
means for connecting the first call to the second call.

19. The apparatus of claim 12 wherein the mobile communications device is selected from the group consisting of a) a mobile phone, b) a personal digital assistance (PDA) device, c) a notebook computer, and d) a two-way pager.

20. The apparatus of claim 12 wherein the means for updating, upon receipt of the message, the account of the user of the mobile communications device to provide the credit for the dropped call is selected from the group consisting of a) means for updating an automatic message accounting (AMA) billing record to credit the account of the user of the mobile communications device for the dropped call and b) means for transmitting a messaging to a billing system to credit the account of the user of the mobile communications device for the dropped call.

21. The apparatus of claim 12 wherein the credit is a function of a predetermined number of minutes.

22. The apparatus of claim 14 wherein the predetermined interval is at least 4 seconds.

23. A method of operating an automatic credit and reconnect of dropped calls system, the method comprising the steps of:
receiving, from a base station, a message that a mobile communications device has experienced a dropped call;
updating, upon receipt of the message, an account of a user of the mobile communications device to provide a credit for the dropped call;
generating a call, via a mobile switching center (MSC), to the mobile communications device after a predetermined interval;
determining, via at least one response to an interactive voice response server, whether to reconnect the mobile communications device to a last call number;
storing, via a data base, the at least one response obtained from the user of the mobile communications device;
re-establishing, via the MSC, a connection between the mobile communications device and the last call number upon an affirmative response from the user of the mobile communications device; and
terminating, via the MSC, the connection to the mobile communications device upon a negative response from the user of the mobile communications device.
